(19) United States
(12) Patent Application Publication
(10) Pub. No.: US 2016/0075073 A1
(43) Pub. Date: Mar. 17, 2016

(54) FLOW CONTROLLED STRAND DIE

(71) Applicant: T.W. Womer & Associates, LLC, Edinburg, PA (US)

(72) Inventor: Timothy WOMER, Edinburg, PA (US)

(73) Assignee: T.W. WOMER & ASSOCIATES, LLC, Edinburg, PA (US)

(21) Appl. No.: 14/483,930

(22) Filed: Sep. 11, 2014

(51) Int. Cl. B29C 47/12; B29C 47/30

(52) U.S. Cl. CPC B29C 47/124; B29C 47/30

(57) ABSTRACT

An extrusion die is used for the simultaneous extrusion of multiple strands of extrusion material at the same flow rate. The extrusion die includes a mounting flange having an inlet cavity with an inlet orifice at one end for receiving extrusion material from an extruder. The extrusion die also includes a valve body including at least one adjustment hole, and a channel body arranged between the mounting flange and the valve body. The channel body defines at least one channel extending therethrough to provide fluid communication for the extrusion material between the inlet cavity and at least one outlet passageway provided in the valve body and respectively corresponding to the at least one adjustment hole. Additionally, a flow control gate is received in each adjustment hole to externally control the flow velocity of the extrusion material through the outlet passageway before it exits the die. Additionally, the flow control gate allows a user to adjust flow rate variations caused by temperature changes across the die.

### FIELD OF THE INVENTION

The present invention relates to an extrusion die for thermoplastic materials having improved material flow control.

### BACKGROUND

Extrusion dies for thermoplastic material, such as polymer resin, are commonly used to simultaneously extrude a plurality of continuous thermoplastic strands from a plurality of die orifices. FIG. 1 shows an extrusion apparatus having a conventional die connected to an end thereof. The die is configured to extrude multiple strands simultaneously. However, one problem encountered in such prior art die members is an unequal flow distribution of the thermoplastic material to the various die orifices. This is generally due to the dies having abrupt directional flow changes for the flowing material in the extruding passages. Additionally, the use of these particular types of dies can result in the disadvantageous accumulation of the thermoplastic material in various regions within the die member, thus diminishing the flow rate or causing stagnation of the accumulated material, which leads to the subsequent deterioration of the thermoplastic material being extruded.

Flow passageways of typical multi-strand dies often have parallel axes, and accumulation of thermoplastic material may occur in a plenum chamber immediately adjacent the row of parallel passageway inlets. The accumulated material that is forced through the passageways and extruded through the die orifices frequently stagnates, causing the deterioration of the material and thereby resulting in the contamination of subsequent thermoplastic material being extruded through the die member. Further, such conventional extrusion dies are designed so that the thermoplastic material must make abrupt changes in the flow direction as the material is forced from the plenum chamber into one of the parallel passageways. This often results in an unequal distribution of the material to the various parallel passageways leading to the die orifices. Consequently, this produces undesirable variations in the size of the diameters of the extruded thermoplastic strands, as well as the ovality of each strand, which negatively affects the use of the extrudate in, for example, 3-D printing. In particular, the extruded polymer strands need to be substantially round, and not oval shaped, in order to properly feed the plastic in the 3-D printing process.

In conventional strand dies, manifold geometry is also often used to allow the thermoplastic material to be distributed evenly to the exit of the die, wherein the outermost strands are smaller in diameter than the innermost stands. If the flow characteristics of the resin changes due to the melting temperature, lot to lot variation, or even a complete change in resin from what the die was originally designed for, then the flow through the die will correspondingly change dramatically. For example, FIG. 2 shows a graph that illustrates how viscosity of extrusion material changes with temperature. Thus, there exists a need for a multi-strand die that can extrude material having variable viscosity depending on the temperature, while maintaining a desired flow rate of the material through the die.

Furthermore, extrusion dies are typically designed so that the resin flow is controlled by the particular geometry of the polymer flow paths so that the polymer is distributed uniformly. For example, in the case of sheet extrusion dies, the manifold area of the die is geometrically designed in this manner, and may also include restrictor bars to the polymer flow path area. The use of such a restrictor bar in a sheet die, or the use of a choker ring in a blow molding die head, allows for coarse adjustment of the polymer flow, whereas fine adjustments are made at the lips of the sheet die or at the exit of the blow molding head. Although these examples of flow adjusting devices are common in various types of extrusion dies to control the uniformity of the extrudate after it exits the die, there exists a need to control the flow of polymer through dies used for the extrusion of strands or monofilaments, such as fishing line, lawn trimmer cord, or fibers. If a multi-hole in-line strand is large enough, the flow to the end holes can be increased by enlarging the passageways, but such an alteration does not provide the flexibility needed for changing the type of resin, and is further not easily, or even capable of being, automated via computer control.

It is thus apparent from the foregoing that conventional extrusion dies have many drawbacks and disadvantages. Thus, there exists a clear need for a die that solves these aforementioned problems, and which provides a quick and easy way to accurately control the flow of resin before it exits the die. The improved extrusion die according to the present invention solves the foregoing problems encountered in the prior art through its ability to extrude multiple strands of polymer simultaneously and uniformly at the same flow rate. Moreover, different resins have different flow characteristics, which makes controlling the flow rate through standard dies very difficult. The improved die according to the present invention is able to accurately control the flow velocity of the polymer and its ovality, even for different resins, by externally controlling the flow of polymer before it exits the die. Accordingly, it is an object of the present invention to provide an improved flow controlled multi-strand extrusion die for thermoplastic material.

### SUMMARY

The present invention provides a multi-strand extrusion die for use with an extruder. The die of the invention allows for an adjustment to be made near the exit orifice(s) from the die to control the pressure of the material to be extruded. In this way, the dimensions of the strand being extruded can be controlled. This control also allows a better control of the residence time of the material in the die, which results in avoiding deterioration of the material to be extruded. The control can be effected manually or automatically.

The multi-strand extrusion die includes a mounting flange configured to mount to the extruder, a channel body defining at least one channel extending therethrough, and a valve body connected thereto. The valve body defines at least one adjustment hole respectively corresponding to the at least one channel, and at least one outlet passageway respectively corresponding to the at least one adjustment hole and in fluid communication therewith. The at least one channel provides fluid communication for extrusion material between the mounting flange and the valve body.

A flow control gate is coupled to the at least one adjustment hole for accurately controlling the flow velocity of the extrusion material. The flow control gate is configured to externally control the flow velocity of the extrusion material through the outlet passageway before it exits the die. Further, a nozzle tip is removably coupled to the at least one outlet passageway for altering the size and/or shape of the extrudate as it exits the die. Each nozzle tip received in a corresponding outlet passageway allows a user to extrude multiple strands of extrusion material having both the same size diameter and the same ovality.

The mounting flange includes an inlet orifice at one end that opens into a conical shaped inlet cavity that includes an apex at an end opposite the inlet orifice having at least one opening respectively corresponding to the at least one channel of the channel body. An intersection point divides the extrusion material evenly into each channel for transporting the extrusion material through the channel body toward a respective outlet passageway.

A connection end of the mounting flange comprises a sunk lip surrounding the inlet orifice. Additionally, a longitudinal axis of the at least one outlet passageway is arranged perpendicularly to the longitudinal axis of the respectively corresponding adjustment hole. Each of the at least one channels has a diameter sized such that the pressure drop through each channel is balanced for attaining a near uniform flow amongst all the channels.

### BRIEF DESCRIPTION OF THE DRAWINGS

The numerous other advantages, features and functions of embodiments of a flow controlled strand die will become readily apparent and better understood in view of the following description and accompanying drawings. The following description is not intended to limit the scope of the die, but instead merely provides exemplary embodiments for ease of understanding.

FIG. 1 illustrates a conventional extrusion apparatus and die.

FIG. 2 is a graph that illustrates how viscosity of extrusion material changes with temperature.

FIG. 3 is a perspective view of the die according to an embodiment of the present invention.

FIG. 4 is a perspective cross-sectional view of the die taken along line 4-4 of FIG. 3 shown without flow-control gates engaged therewith.

FIG. 5 is a perspective cross-sectional view of the die along line 5-5 of FIG. 3.

FIG. 6 is a top view of the die of FIG. 3.

FIG. 7 is a side view of the die of FIG. 3.

FIG. 8 is a front view of the die of FIG. 3.

FIG. 9 is a side view of the die according to another embodiment of the present invention.

FIG. 10 is a view of the die along line 10-10 of FIG. 9.

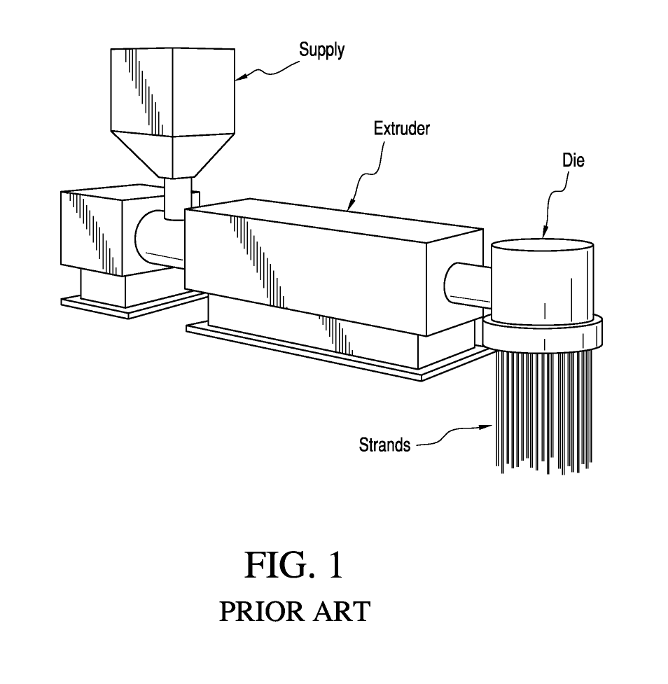

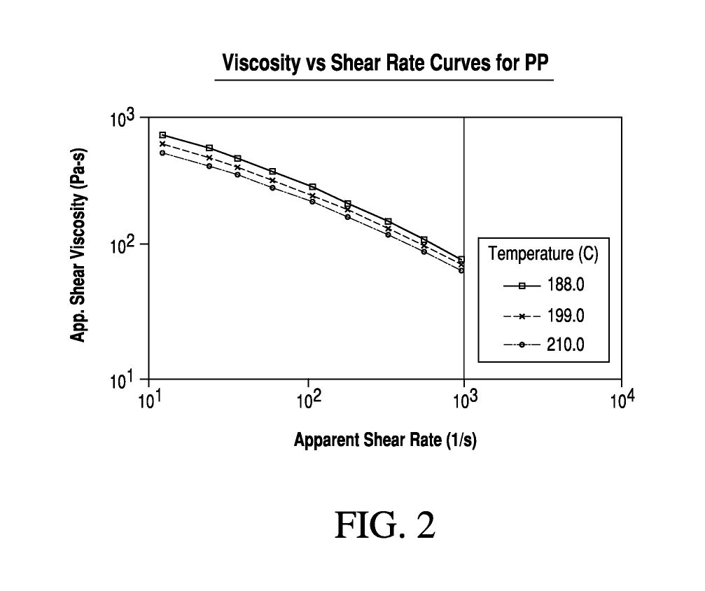

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary configurations of a die, and in no way limit the structures or configurations of a die thereof according to the present disclosure.

### DETAILED DESCRIPTION

A better understanding of different embodiments of the invention may be had from the following description read in conjunction with the accompanying drawings in which like reference characters refer to like elements.

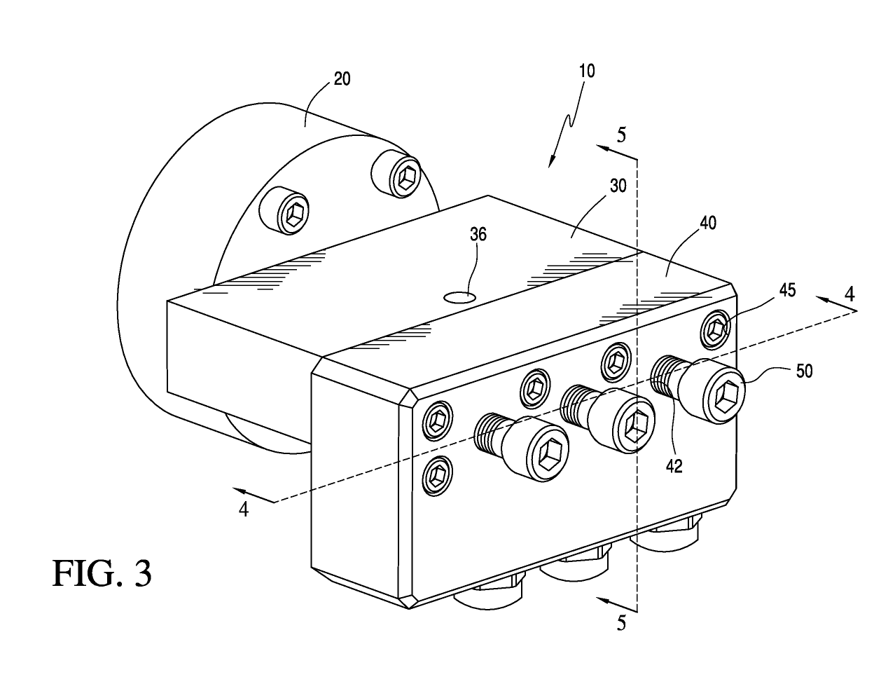

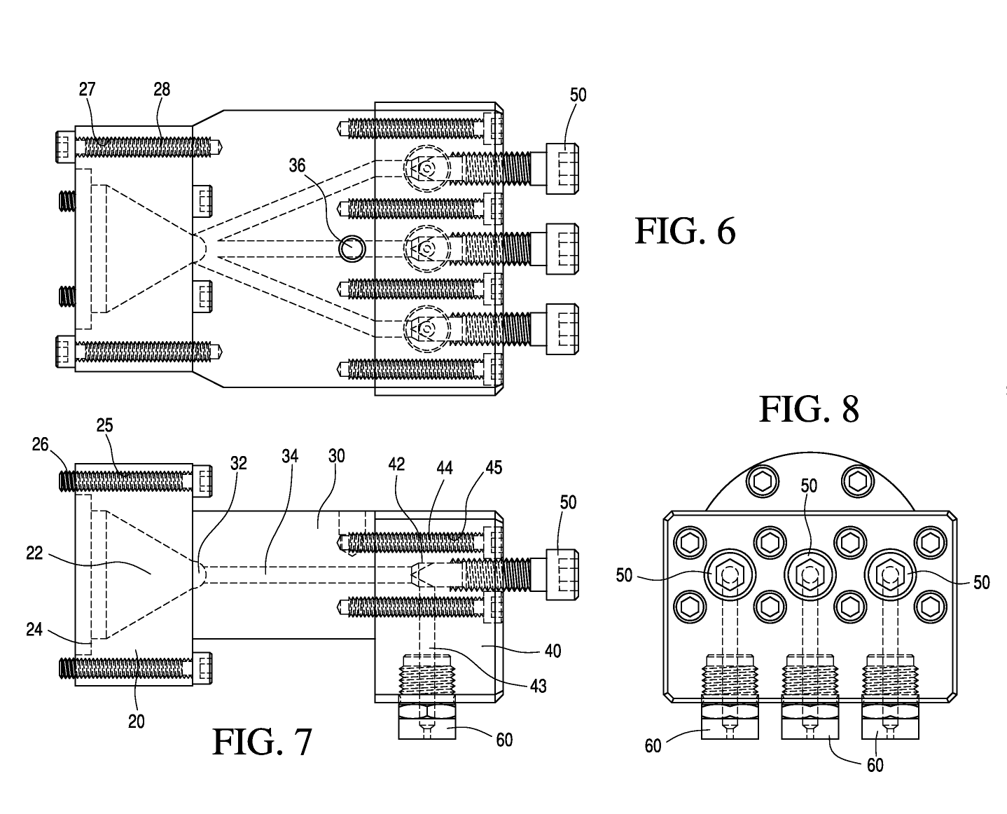

FIG. 3 shows a multi-strand extrusion die 10 for use with an extruder (not shown). The multi-strand extrusion die includes a mounting flange 20, a channel body 30 and a valve body 40, and may be integrally formed or connected via a series of fasteners such as threaded bolts. For instance, suitable bores 27, 45, may be provided in the mounting flange, channel body and valve body to receive threaded bolts 28, 44 to securely interconnect each section of the die (see FIGS. 6 and 7). Other bores 25 may be provided for receiving threaded bolts 26 to securely connect the mounting flange 20 of the die to an extruder (see FIG. 7).

The extrusion die 10 allows for the simultaneous extrusion of multiple strands of extrusion material, such as thermoplastic resin, wherein each strand can be extruded at a precise flow rate. It should be appreciated that each strand can further be extruded at the same flow rate. Some examples of extrusion material for use with the die 10 include plastic polymer resin such as acrylonitrile butadiene styrene (ABS), high impact polystyrene (HIPS) and polylactic acid (PLA), among others. It should be appreciated that other types of material can also be extruded through the die 10, such as various food products (and pet food products) or other types of material that can turn to a liquid state before or upon entering the die (i.e. from heating), and which can turn to a solid state upon exiting the die (i.e. from cooling or drying). A tap 36 may be provided in the die, such as in a top surface of the channel body 30 for accommodating a tool.

The multiple strands of extrudate can be used in the production of 3-D printing applications that use monofilament strands, such as in the production of fishing line or lawn trimmer cord, or any application which may require precise geometry for each strand that is produced. The ability to precisely control the flow rate of the extrusion material ensures that each strand produced has the same size, i.e. the same diameter, and also the desired ovality. For example, air entrapment within conventional dies can cause the resulting extruded strands to have an oval-shaped cross-section. The use of such oval-shaped, or oblong, strands in 3-D printing can have a negative effect since they cannot feed properly into the 3-D printing process. The present die 10 solves this problem by producing strands having an optimal ovality defining a circular, or round, cross-section in order to feed properly into a 3-D printing process.

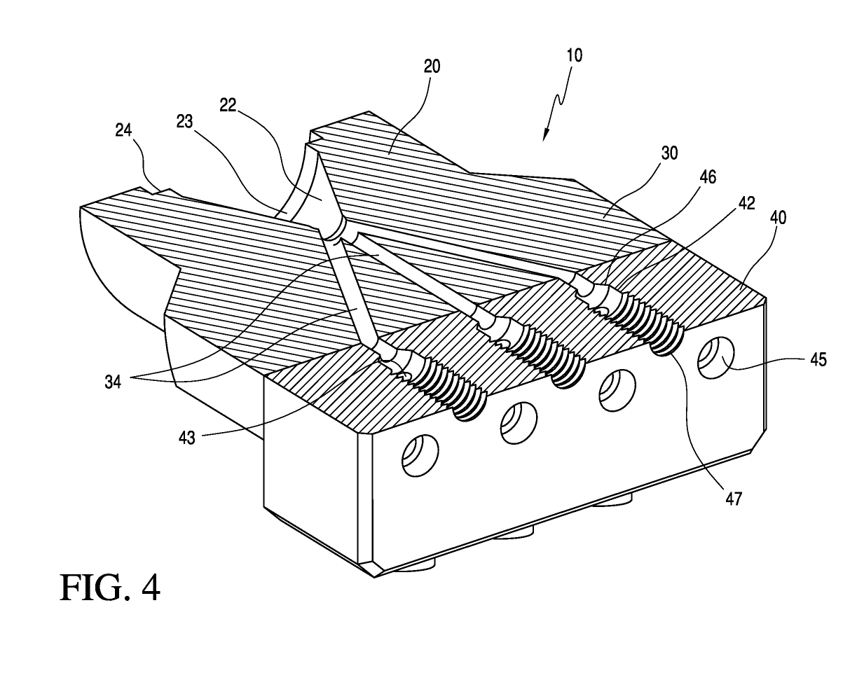

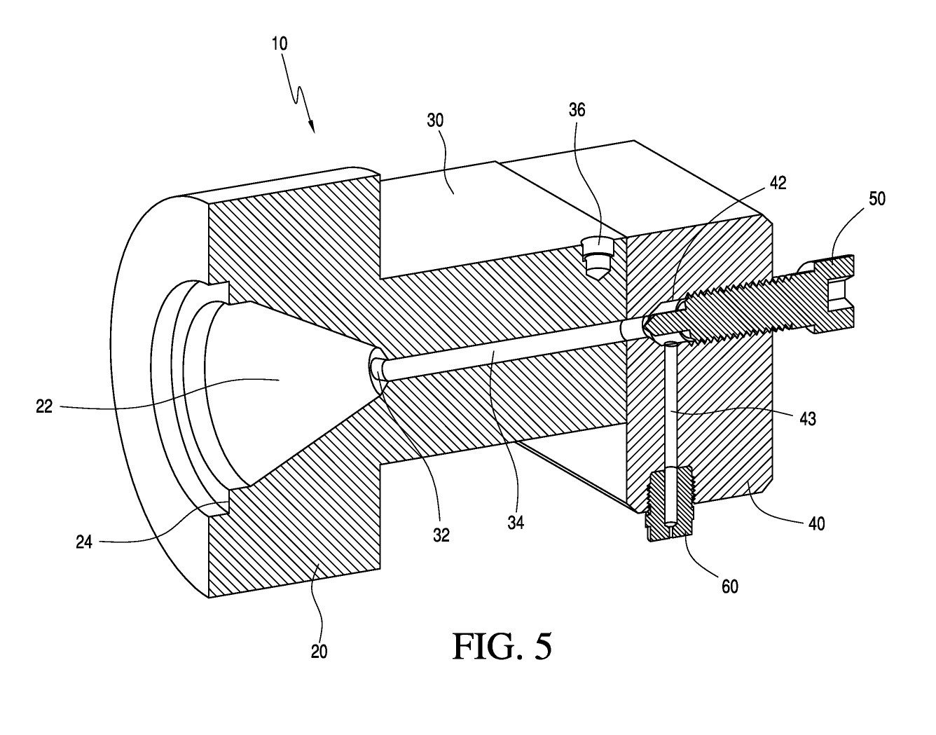

As shown in FIGS. 4 and 5, the mounting flange 20 includes a conical shaped inlet cavity 22 having an inlet orifice 23 for receiving the extrusion material from the extruder. A sunk lip 24 that surrounds the inlet orifice 23 may be formed in the mounting flange for connecting to the extruder. An apex 32 of the conical shaped inlet cavity 22 defines an intersection point from which at least one channel or passageway 34 extends from the apex 32 through the entire length of the channel body or manifold 30 for transporting extrusion material therethrough. Referring to FIGS. 4 and 6, for example, the apex 32 divides the extrusion material evenly into a plurality of separate branching distinct portions for passage through channels 34, with subsequent channeling through separate respectively corresponding distinct outlet passageways 43 for extrusion to the desired shape.

The at least one channel 34 provides fluid communication for the extrusion material to travel from the inlet cavity 22 to the valve body 40. The valve body 40 includes at least one adjustment hole 42 respectively corresponding to the at least one channel 34. Still referring to FIGS. 4 and 6, the die 10 shown has three channels 34 extending from the apex 32 through the entire length of the channel body 30, and three adjustment holes 42 corresponding to the respective channels 34, although it should be appreciated that any number of channels and respectively corresponding adjustment holes is possible. For example, the die 10 may have four channels 34 and four respectively corresponding adjustments holes 42 for producing four separate distinct strands.

Each adjustment hole 42 includes a first end 46 and an oppositely located second end 47. The first end 46 of each adjustment hole 42 is configured to receive the extrusion material from the corresponding channel 34. The second end 47 of the adjustment hole 42 is configured to receive an adjustable flow control gate 50, such as a needle valve. Each adjustment hole 42 may have a larger diameter than the corresponding channel 34 to which it connects to. As shown in FIGS. 5 and 7, each adjustment hole 42 perpendicularly connects to a corresponding cylindrical outlet passageway 43, such that any extrusion material that is received in the adjustment hole 42 from the corresponding channel 34 can be diverted into the outlet passageway 43 to pass therethrough and out of the valve body 40 in a cylindrical strand form. It should further be appreciated that the outlet passageway 43 may have a rectangular or square cross-section, or any other cross-sectional shape desired, in order to produce an extruded strand having such a desired shape.

The die 10 is able to provide improved accuracy control of the flow velocity of the extrusion material during the extrusion process, even for different types of resin material which may exhibit different flow characteristics, including viscosity, density and heat transfer properties. In particular, the dimensions of the three channels 34 shown in FIG. 4 are arranged so that the pressure drop through each is balanced to achieve as much flow uniformity as possible. For example, the two outermost channels are longer than the middle channel, and thus the outermost channels are provided with a proportionately larger diameter than that of the middle channel in order to mathematically balance the pressure drop through each channel so that a near uniform flow amongst all the channels is attained. Further, the surfaces of the inlet cavity 22, as well as the at least one channel 34 and respectively corresponding adjustment hole 42 and outlet passageway 43, all have a smooth, polished finish, in order to facilitate a frictionless flow of the extrusion material therethrough, and thus do not offer any impediment to the flow. Moreover, the design made from the outermost to the middle channels are often unique to each die to best accommodate the different parameters of the particular extrusion operation and die, including the number of channels, extrusion rate, materials, temperature, and pressure.

However, the geometrical design alone of the flow channels 34 does not allow a user to make fine-tune adjustments to the flow rate of the extrudate during the extrusion process as it exits the die 10. Thus, the inclusion of an adjustable flow control gate 50, such as a threaded needle valve, that is received within a corresponding adjustment hole 42 advantageously provides further flow balance to the extrudate by allowing a user to externally control the flow of extrusion material before it exits the die. As the user loosens the flow control gate 50 toward an open position, more extrusion material is allowed to flow faster from the at least one channel 34 and into a respective outlet passageway 43 from which it exits the die. Conversely, as the user tightens the flow control gate toward a closed position, the flow rate of the extrusion material slows down and less material is able to pass from the at least one channel 34 into a respective outlet passageway 43 and then subsequently exit the die.

Each flow control gate 50 allows for miniscule adjustments and further assists in fine tuning the accuracy of the flow velocity of the extrusion material on the fly during the extrusion process. The use of a separate removable flow control gate 50 coupled to each respective adjustment hole 42 also allows the user to ensure that the flow velocities of each extruded strand are equal so that multiple strands can be extruded simultaneously at the same exact flow rate. The improved accuracy control of the flow rate of extrusion material also helps improve the ovality of the strands.

Each flow control gate 50 may be automated. For example, computerized measurement software can be employed downstream from the extruded strands so that the size of each strand can be measured simultaneously, and then the measurement is sent back to a software program that adjusts each flow control gate accordingly based on the measurement reading. Upon measuring the size of the strands, the software program fine-tunes any needle valve that corresponds to a strand that requires size adjustment or flow velocity adjustment of extrusion material passing through the corresponding adjustment hole 42.

Additionally, a removable nozzle tip 60 is respectively coupled to an outlet end of each outlet passageway 43 in order to easily change the size or shape of the diameter of each exiting strand of extrudate as shown in FIGS. 7 and 8. For example, the strand diameter size or shape can be easily changed depending on the orifice size or shape of each removable nozzle tip 60. Each nozzle tip 60 may have a circular, rectangular or square cross-section, or any other cross-sectional shape desired, in order to produce an extruded strand having such a desired shape. It is therefore possible to produce a plurality of extruded strands having the same size when the orifice of each nozzle tip is the same size. Conversely, it is also possible to produce a plurality of different sized strands when the orifice of each nozzle tip is a different size. Thus, the use of a flow control gate 50 working in combination with a corresponding nozzle tip 60 allows different sized strands to be extruded simultaneously from the outlet passageways. Moreover, separate nozzle tips having orifices of different sizes and shapes can be attached to each separate outlet passageway to create a plurality of distinctly sized and shaped extrudate strands.

The die 10 is configured for attachment to an extruder such that the extrusion material can travel in the at least one channel 34 in a direction along the length of the die. To ensure optimal ovality of each extruded strand, such that each strand defines a circular cross-section instead of an oblong cross-section, it is necessary for the strands to be extruded completely vertically, or in other words in the direction of the gravitational forces, and then preferably fed into a bath of chilled or warm water in order to solidify the material being processed. Horizontal extrusion, or extrusion in any other direction except straight down, on the other hand, can disadvantageously result in increased ovality of the cross-section of the strands since gravitational forces will naturally tend to stretch an axis of the strand in the direction thereof

It should be appreciated, however, that the strands are not required to be vertically extruded, such as when optimal ovality of the strands is not necessary or desired. For example, for use in applications other than 3-D printing, the strands can be extruded horizontally or at any other desired angle. This can be achieved by connecting the channel body 30 and the valve body 40 at a desired angle such that the longitudinal axis of each adjustment hole 42 is similarly angled relative to the longitudinal axis of each corresponding channel 34. Since the outlet passageway 43 remains perpendicularly connected to the adjustment hole 42, the strands of extrusion material are therefore extruded out of the outlet passageway in a direction dependent on the angle formed between each adjustment hole and corresponding channel 34.

In a further variation of the die 10, besides controlling the polymer flow via the sizing of the flow channels in the die body and the fine tuning of the flow by means of the needle valve, automated size control of the strands may also be incorporated so that any upstream variation in the flow characteristic of the extrusion material can be adjusted. For example, ultra-sonic measuring equipment can be used to measure the extruded strand size directly downstream from the die, and a secondary needle valve can be added to the die prior to the nozzle tip 60. Such a secondary valve allows for size adjustment of each strand to be within thousandths of an inch.

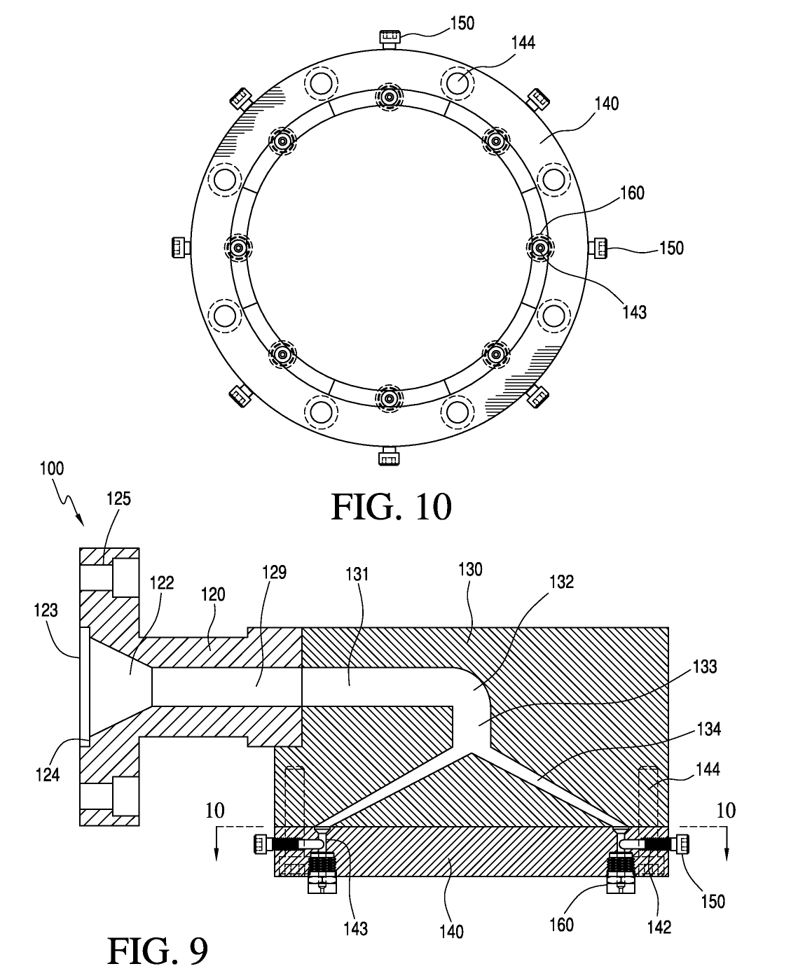

FIGS. 9-10 show another multi-strand die 100 for use with an extruder. The multi-strand extrusion die 100 includes a mounting flange 120, a channel body 130 and a valve body 140. These sections may be integrally formed or connected together via a series of fasteners, such as threaded bolts, that can be inserted into receiving bores in each section. For instance, threaded bolts 144 may be used to removably secure the channel body 130 to the valve body 140. Additional bores may be provided in each section for receiving a securing fastener therein. For example, bores 125 may be provided in the mounting flange for receiving fasteners, such as threaded bolts, to removably connect the die 100 to an extruder.

The mounting flange 120 includes a conical shaped inlet cavity 122 having an inlet orifice 123 for receiving the extrusion material from the extruder. A sunk lip 124 may be formed in the mounting flange surrounding the inlet orifice 123 for connecting, aligning, and/or mating to the extruder. An apex of the conical shaped inlet cavity 122 defines an entrance to a first conduit 129 that extends through the mounting flange and which is in fluid communication with a second conduit 131 formed in the channel body 130. The second conduit 131 is in further fluid communication with a third conduit 133 formed in the channel body 130. An elbow joint 132 is formed between the second and third conduits, and may be configured so that the longitudinal axes of the second and third conduits are perpendicular. The third conduit 133 is in further fluid communication with a dividing point from which at least one channel or passageway 134 branches out.

The at least one channel 134 extends both downward and radially outward in a direction toward the periphery of the channel body 130. The dimensions of each channel 134 may be exactly the same, i.e. no channel is longer or shorter than another channel, so that they form a circular profile. The dividing point divides the extrusion material evenly into a plurality of separate branching portions for passage through each channel 134. Each channel 134 is in further fluid communication with a corresponding outlet passageway 143 configured to extend vertically downward through the valve body 140. After passing through each channel 134, the extrusion material subsequently passes through separate respective outlet passageways 143 for extrusion to the desired shape.

The valve body 140 also includes an adjustment hole 142 corresponding to each outlet passageway 143. In particular, each adjustment hole 142 is arranged at the outer side of the valve body 140 and perpendicularly connects to a corresponding outlet passageway 143. Each adjustment hole 142 is configured to receive an adjustable flow control gate 150, such as a threaded needle valve. By adjusting the flow control gate 150, such as by further inserting the needle valve into the adjustment hole 142, further flow balance is advantageously provided to the extrudate. Thus, the user can externally control the flow of extrusion material before it exits the die. As the user loosens the flow control gate 150 toward an open position, more extrusion material is allowed to flow faster through the corresponding outlet passageway 143 as it exits the die. Conversely, as the user tightens the flow control gate toward a closed position, the flow rate of the extrusion material slows down and less material is able to pass through the corresponding outlet passageway 143 and then subsequently exit the die. As an alternative, the valve gate 150 can be a ball valve, instead of a needle valve.

Each flow control gate 150 allows for fine adjustments and further assists in tuning the accuracy of the flow velocity of the extrusion material on the fly during the extrusion process. The use of a separate removable flow control gate 150 coupled to each respective adjustment hole 142 also allows the user to ensure that the flow velocities of each extruded strand are equal so that multiple strands can be extruded simultaneously at the same exact flow rate. Although the channels 134 in the multi-strand die may have exactly the same dimensions since they radially branch outward from the division point to form a circular profile, the needle valve 150 allows the user to adjust flow rate variations caused by temperature differences across the die, resistance imperfections or irregularities along the inside walls of channels 134 and/or nozzles 160, and/or dimensional deviations within design tolerances.

A removable nozzle tip 160 may be respectively coupled to an outlet end of each outlet passageway 143 in order to easily change the size or shape of the diameter of each exiting strand of extrudate. The strand diameter size or shape can be easily changed depending on the orifice size or shape of each removable nozzle tip 160, which may have a circular, rectangular, square, or any other cross-sectional shape desired, in order to produce an extruded strand having such a shape. When the orifice of each nozzle tip is the same size, the multiple simultaneously extruded strands also have the same size. Conversely, it is possible to simultaneously produce a plurality of different sized strands when the orifice of each nozzle tip is a different size.

Referring to FIG. 10, the die 100 has eight identical channels 134 equally spaced apart and radially extending toward the outer periphery of the channel body 130 so as to be arranged in a circular manner therein. In particular, FIG. 10 shows each outlet passageway and nozzle tip corresponding to each channel 134 is arranged in a circular manner in the valve body 140. It should be appreciated, however, that any number of channels and respectively corresponding adjustment holes is possible.

Although the embodiments have been disclosed in the context of certain exemplary embodiments, it therefore will be understood by those skilled in the art that the present invention extends beyond the specifically disclosed embodiments to other alternative embodiments, combinations of embodiments, and/or uses of the invention and modifications and equivalents thereof. Thus, it is intended that the scope of the present invention herein disclosed should not be limited by the particular disclosed embodiments described above.

What is claimed is:

1. An extrusion die for use with an extruder, the extrusion die comprising:
a mounting flange configured to mount to the extruder;
a channel body defining at least one channel extending therethrough;
a valve body defining at least one adjustment hole respectively corresponding to the at least one channel, and at least one outlet passageway respectively corresponding to the at least one adjustment hole and in fluid communication therewith,
wherein the at least one channel provides fluid communication for extrusion material between the mounting flange and the valve body; and
a flow control gate coupled to the at least one adjustment hole for accurately controlling the flow velocity of the extrusion material.

2. The extrusion die according to claim 1, further comprising a nozzle tip removably coupled to the at least one outlet passageway.

3. The extrusion die according to claim 1, wherein the mounting flange further comprises an inlet orifice at one end that opens into a conical shaped inlet cavity.

4. The extrusion die according to claim 3, wherein the inlet cavity includes an apex at an end opposite the inlet orifice having at least one opening respectively corresponding to the at least one channel of the channel body.

5. The extrusion die according to claim 3, wherein a connection end of the mounting flange comprises a sunk lip surrounding the inlet orifice.

6. The extrusion die according to claim 1, wherein a longitudinal axis of the at least one outlet passageway is arranged perpendicularly to the longitudinal axis of the respectively corresponding adjustment hole.

7. The extrusion die according to claim 6, wherein the at least one channel further comprises at least two channels, each channel having a diameter sized such that the pressure drop through each channel is balanced for attaining a near uniform flow amongst all the channels.

8. The extrusion die according to claim 6, wherein the at least one outlet passageway has a circular cross-section.

9. The extrusion die according to claim 6, wherein the at least one outlet passageway has a square cross-section or rectangular cross-section.

10. The extrusion die according to claim 2, wherein an orifice of the nozzle tip has a circular cross-section.

11. The extrusion die according to claim 2, wherein an orifice of the nozzle tip has a square cross-section or rectangular cross-section.

12. A multi-strand extrusion die for the simultaneous extrusion of multiple strands of extrusion material at the same flow rate, the extrusion die comprising:
a mounting flange including an inlet cavity having an inlet orifice at one end for receiving extrusion material from an extruder;
a valve body including at least one adjustment hole having a first end and a second end;
a channel body arranged between the mounting flange and the valve body, the channel body defining at least one channel extending therethrough to provide fluid communication for the extrusion material between the inlet cavity and the first end of the corresponding at least one adjustment hole;
the valve body further defining at least one outlet passageway respectively corresponding to and in fluid communication with the at least one adjustment hole, wherein the at least one outlet passageway is arranged perpendicular to the corresponding at least one adjustment hole; and
at least one flow control gate configured to externally control the flow velocity of the extrusion material through the outlet passageway before it exits the die.

13. The multi-strand extrusion die according to claim 12, wherein the at least one flow control gate is received in the second end of the corresponding at least one adjustment hole.

14. The multi-strand extrusion die according to claim 13, wherein the flow control gate is a needle valve.

15. The multi-strand extrusion die according to claim 13, further comprising at least one nozzle tip received in the corresponding at least one outlet passageway for extruding multiple strands of extrusion material having the same size diameter and the same ovality.

16. The multi-strand extrusion die according to claim 12, wherein the inlet cavity has a conical shape and includes an apex formed at an end opposite the inlet orifice, wherein the apex defines an intersection point that divides the extrusion material evenly into each of the at least one channel for transporting the material through the channel body.

17. The multi-strand extrusion die according to claim 12, wherein the at least one control gate is automated based on downstream measurements of the extruded strands.

18. A die for simultaneously extruding multiple strands of a material, the die comprising:
a mounting flange configured to mount to an extruder, the mounting flange including a first conduit for passage of the material therethrough;
a valve body including at least one vertically disposed outlet passageway and at least one corresponding horizontally disposed adjustment hole;
a channel body connected to both the mounting flange and the valve body, the channel body including at least a second conduit in fluid communication with the first conduit, and at least one channel respectively corresponding to the at least one outlet passageway and extending both vertically downward and radially outward from a dividing point of the at least second conduit toward the valve body; and
an adjustable flow control gate respectively received in each at least one adjustment hole for adjusting flow rate variations of the material caused by differences across the die.

19. The die according to claim 18, further comprising a nozzle tip removably coupled to each of the at least one outlet passageway.

20. The die according to claim 19, wherein the at least one channel further comprises at least two channels each having the same shape and length.
